(19) United States
(12) Patent Application Publication
(10) Pub. No.: US 2016/0098128 A1
(43) Pub. Date: Apr. 7, 2016

(54) INPUT DEVICES AND RELATED SYSTEMS AND METHODS

(71) Applicant: T+Ink, Inc., New York, NY (US)

(72) Inventors: Terrance Z. Kaiserman, Loxahatchee, FL (US); John Gentile, Montclair, NJ (US); Anthony Gentile, New York, NY (US); Tayler Kaiserman, Brooklyn, NY (US); Steven Martin Cohen, New York, NY (US)

(73) Assignee: T+Ink, Inc., New York, NY (US)

(21) Appl. No.: 14/709,112

(22) Filed: May 11, 2015

Related U.S. Application Data
(60) Provisional application No. 61/990,868, filed on May 9, 2014.

(51) Int. Cl. G06F 3/045

(52) U.S. Cl. CPC G06F 3/045; G06F 2203/04103

(57) ABSTRACT

Input devices for sensing and transmitting digital information imparted by human touch are generally described. The input devices may be one-dimensional or two-dimensional input devices for entering data from a flat surface. Associated systems and methods are also described.

### RELATED APPLICATIONS

This application claims priority to U.S. Provisional Application No. 61/990,868, filed May 9, 2014, which is incorporated herein by reference in its entirety.

### FIELD

The present invention relates to input devices and, in particular, input devices for entering digital information imparted by human touch

### BACKGROUND OF INVENTION

There have been many input devices for entering data to computers and digital machinery. In recent decades, there has been a revolutionary transition from typewriters, which caused mechanically molded letters to physically strike paper, to the touchscreen keyboards of present day phones and tablets. Similarly, control knobs in the form of mechanical rheostats have made the transition from the rotation of a physical shaft to linear mechanical faders through the input of digital numbers to impart what formerly was the attenuation and proportional splitting of analog signals.

With the advent of conductive inks and modern printing techniques, it is now possible to sense the touching of a flat surface with fingers as if a switch and/or switches were being closed or a fader were being slid. This has application to a new class of input devices enabling communication via fingers and hands directly with flat paper and/or surfaces upon which sensing elements and associated circuitry have been applied.

### SUMMARY OF INVENTION

The present invention relates to input devices and, in particular, input devices for entering digital information imparted by human touch. The subject matter of the present invention involves, in some cases, interrelated products, alternative solutions to a particular problem, and/or a plurality of different uses of one or more systems and/or articles.

In some embodiments, a printed substrate for a flat computation, communication, and I/O system comprises a non-conductive substrate; at least one first touch sensitive conductive element; and at least one second touch sensitive conductive element not in electrical contact with said at least one first touch sensitive conductive element.

In another set of embodiments, a device comprises a non-conductive substrate and at least one touch-sensitive switch, wherein the at least one touch-sensitive switch is printed on the non-conductive substrate. In some embodiments, the at least one touch-sensitive switch comprises a first touch-sensitive conductive element and a second touch-sensitive conductive element, wherein the second touch-sensitive conductive element is not in electrical contact with the first touch-sensitive conductive element.

In some embodiments, a method comprises providing a device, wherein the device comprises a non-conductive substrate and at least one touch-sensitive switch. In some embodiments, the at least one touch-sensitive switch is printed on the non-conductive substrate. In some embodiments, the at least one touch-sensitive switch comprises a first touch-sensitive conductive element comprising a conductive ink and a second touch-sensitive conductive element comprising a conductive ink, wherein the second touch-sensitive conductive element is not in electrical contact with the first touch-sensitive conductive element. In some embodiments, the method further comprises positioning a human finger such that a conductive bridge is formed between the first touch-sensitive conductive element and the second touch-sensitive conductive element.

In another set of embodiments, a printed substrate for a flat computation, communication, and I/O system comprises a non-conductive substrate; at least one first touch sensitive conductive element; at least one second touch sensitive conductive element not in electrical contact with said first touch sensitive conductive element; at least one power source; a microprocessor; and electronics.

In some embodiments, a device comprises a non-conductive substrate; a first conductive rail comprising a first touch-sensitive conductive element; and a second conductive rail comprising a second touch-sensitive conductive element, wherein the second conductive rail is not in electrical contact with said first conductive rail.

In some embodiments, a printed substrate for a flat computation, communication, and I/O system comprises a non-conductive substrate; at least one first touch sensitive conductive element; at least one second touch sensitive conductive element not in electrical contact with said first touch sensitive conductive element; at least one third touch sensitive conductive element not in electrical contact with said second touch sensitive conductive element and said first touch sensitive conductive element; at least one power source; a microprocessor; and electronics.

In some embodiments, a device comprises a non-conductive substrate; a first touch-sensitive conductive element; a second touch-sensitive conductive element not in electrical contact with said first touch-sensitive conductive element; and a third touch-sensitive conductive element not in electrical contact with said second touch-sensitive conductive element or said first touch-sensitive conductive element.

In some embodiments, a printed substrate for a flat computation, communication, and I/O system comprises a non-conductive substrate; at least one first touch sensitive conductive element; at least one second touch sensitive conductive element not in electrical contact with said at least one first touch sensitive conductive element, said at least one first touch sensitive conductive element and said at least one second touch sensitive conductive element forming at least one touch sensitive switch; at least one power source; a microprocessor; and electronics.

In another set of embodiments, a device comprises a non-conductive substrate and a matrix of touch-sensitive switches. In some embodiments, each touch-sensitive switch comprises a first touch-sensitive conductive element and a second touch-sensitive conductive element.

In some embodiments, a method comprises positioning a human finger such that it closes at least one touch-sensitive switch of a matrix comprising a plurality of touch-sensitive switches.

In some embodiments, a data generation and mathematical variable alteration method comprises at least two switches located within an area; at least one memory storage register for storage of at least one variable; and processing ability to increment and/or decrement said at least one variable.

In some embodiments, a device comprises at least two switches located within an area; at least one memory storage register for storage of at least one variable; and a microprocessor. In some embodiments, the microprocessor has processing ability to increment and/or decrement said at least one variable.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

FIG. 1 shows an exemplary embodiment of a touch-sensitive switch.

FIG. 2 shows a schematic representation of a touch-sensitive switch, according to some embodiments.

FIG. 3 shows an exemplary embodiment of a linear slide potentiometer.

FIG. 4 shows clusters of touch-sensitive switches, according to some embodiments.

FIG. 5 shows an exemplary embodiment of a variable resistance slide potentiometer.

FIG. 6 shows an exemplary embodiment of a variable resistance slide potentiometer with calibration points.

FIG. 7 shows an exemplary embodiment of a two-by-two matrix of touch-sensitive switches.

FIG. 8 shows a schematic representation of a two-by-two matrix of touch-sensitive switches.

FIG. 9 shows a schematic representation of an eight-by-eight matrix of touch-sensitive switches.

FIG. 10 shows a schematic representation of a circuit including a variable resistance slide potentiometer.

FIG. 11 shows an exemplary embodiment of an up-down controller.

FIG. 12 shows an exemplary embodiment of an area controller using four touch-sensitive switches to change an X and Y position.

FIG. 13 shows an exemplary embodiment of an area controller using six touch-sensitive switches to change an X and Y position.

FIG. 14 shows an exemplary embodiment of a four touch point controller changing an X and Y position.

FIG. 15 shows a CIE color chart.

The following reference numbers are used in the figures:
1 conductive element
2 long conductive element
3 insulating space
4 interleaving conductive elements
5 simplified touch electrode
6 simplified long conductive element
8 linear slide pot
9 touch point
10 simplified long conductive element
11 first conductive element
12 second conductive element
13 third conductive element
14 fourth conductive element
15 fifth conductive element
16 sixth conductive element
17 seventh conductive element
18 eighth conductive element
19 ninth conductive element
20 tenth conductive element
21 two element linear controller
22 simplified long conductive element
23 down direction touch point
24 up direction touch point
29 simplified long conductive element
30 any conductive element
31 any conductive element (adjacent to any conductive element 30)
32 any conductive element (adjacent to any conductive element 31)
33 any conductive element (adjacent to any conductive element 32)
34 any conductive element (adjacent to any conductive element 33)
35 any conductive element (adjacent to any conductive element 34)
36 any conductive element (adjacent to any conductive element 35)
40 first touch zone cluster
41 second touch zone cluster
42 third touch zone cluster
50 right conductive electrode
51 left conductive electrode
52 insulating space
54 variable resistance slide pot
55 Fixed resistor
56 center tap (between fixed resistor 55 and variable resistance slide pot 54)
58 positively applied voltage
59 ground
60 enhanced right conductive electrode
61 enhanced left conductive electrode
62 zero calibration touch point
63 quarter scale calibration touch point
64 half scale calibration touch point
65 three quarter calibration touch point
66 full scale calibration touch point
68 insulating space
69 insulating space
71 upper right H
72 upper right V
73 lower right H
74 lower right V
75 upper left H
76 upper left V
77 lower left H
78 lower left V
80 upper horizontal bus
81 lower horizontal bus
82 right vertical bus
83 left vertical bus
84 lower right insulation patch
85 upper right insulation patch
86 lower left insulation patch
87 upper left insulation patch
90 upper right cross point
91 lower right cross point
92 upper left cross point
93 lower left cross point
101 horizontal bus 0
102 horizontal bus 1
103 horizontal bus 2
104 horizontal bus 3
105 horizontal bus 4
106 horizontal bus 5
107 horizontal bus 6
108 horizontal bus 7
110 vertical bus 0
111 vertical bus 1
112 vertical bus 2
113 vertical bus 3
114 vertical bus 4
115 vertical bus 5
116 vertical bus 6
118 vertical bus 7
120 four point common
121 south touch point
122 east touch point
123 north touch point
124 west touch point
125 four point area controller
130 six point common
131 180 degree touch point
132 120 degree touch point
133 60 degree touch point
134 0 degree touch point
135 300 degree touch point
136 240 degree touch point
137 six point area controller
140 X, Y starting value
141 virtual direction
143 trajectory path 140-145
144 trajectory path 140-146
145 Xn, Yn ending value
146 Xne, Yne ending value
150 blue
151 red
152 green
153 CIE white

### DETAILED DESCRIPTION

Input devices for sensing and transmitting digital information imparted by human touch are generally described. Associated systems and methods are also described.

The input devices described herein may be used as part of a computation system (e.g., an electronic system that is capable of processing information), a communication system (e.g., an electronic system that transmits information from a first location to a second location), and/or an input/output (I/O) system (e.g., an electronic system that communicates between a computation system and an environment external to the computation system). The computation system, communication system, and/or I/O system may comprise a memory storage device (e.g., a device comprising a microprocessor) that can store at least one variable. The variable may be a mathematical variable that has at least one component that is real, imaginary, or complex. In some embodiments, the input device is a one-dimensional input device that provides information indicating whether a single-component variable should be modified (e.g., incremented or decremented) and, if so, how much the variable should be modified. For example, an exemplary embodiment of a one-dimensional input device is an up-down controller. In some embodiments, the input device is a two-dimensional input device that provides information indicating whether (and by how much) a first component of the variable should be modified and, separately, whether (and by how much) a second component of the variable should be modified.

In some embodiments, the input device comprises a touch-sensitive switch. The touch-sensitive switch may comprise at least a first touch-sensitive conductive element (e.g., electrode) and a second touch-sensitive conductive element (e.g., electrode), where the first touch-sensitive conductive element is not in electrical contact with the second touch-sensitive conductive element. The touch-sensitive switch may be configured such that a finger (e.g., a human finger, a finger comprising skin) can close the switch. For example, the touch-sensitive switch may be configured such that a finger can simultaneously touch at least a portion of the first conductive element and at least a portion of the second conductive element. The finger may thereby form a conductive bridge between the first conductive element and the second conductive element. As discussed in more detail below, the first touch-sensitive conductive element and/or second touch-sensitive conductive element may comprise a conductive ink.

In some embodiments, the input device comprises a non-conductive substrate. The substrate may be flat, according to some embodiments. In some cases, the substrate may be flexible, rigid, or semi-rigid. In certain embodiments, the substrate may comprise at least one layer of a non-conductive ink. In some cases, the substrate may comprise a ceramic, a plastic, or any other non-conductive material. The touch-sensitive switch may, in some embodiments, be printed on the substrate. For example, the touch-sensitive switch may be printed using a conductive ink. In some cases, the input device further comprises a protective layer formed from a z-axis non-isotropic deposition of ink.

As noted above, the touch-sensitive switch may comprise a conductive ink. Conductive ink generally refers to ink that conducts electricity. In some embodiments, the conductive inks used herein comprise a conductive material that is formed by the evaporation and/or curing of a binder/carrier liquid in which a conductive material is suspended. Non-limiting examples of conductive inks include, but are not limited to, metallic inks, such as aluminum ink, and carbon-containing inks. In some embodiments, conductive ink may be printed on a substrate via an ink jet printer or a three-dimensional printer.

In some embodiments, the input device comprises discrete components in whole or in part in conjunction with combinations of conductive and non-conductive inks.

In some cases, the touch-sensitive switch is part of an electrical circuit. The electrical circuit may further comprise at least a voltage source (e.g., a power source) and electronics. The electronics ma and can include, for example, a digital input sensing device (e.g., a device that can detect whether a switch is open or closed). When the touch-sensitive switch is open (e.g., there is no electrical contact between the first and second conductive elements), relatively little (e.g., substantially no) current may flow through the circuit. When the touch-sensitive switch is closed (e.g., a finger provides a conductive bridge between the first and second conductive elements), a relatively large amount of current may flow through the circuit. The voltage measured at a location in the electrical circuit may be larger when the touch-sensitive switch is closed than when the switch is open. The resistance measured across the touch-sensitive switch may be lower when the touch-sensitive switch is closed than when the switch is open. In some cases, the digital input sensing device may detect whether the touch-sensitive switch is open or closed by measuring a change in voltage, current, and/or resistance.

In some embodiments, the digital input sensing device is connected (e.g., optically or electronically connected) to a microprocessor. The microprocessor may store at least one variable (e.g., a mathematical variable that is real, imaginary, or complex). The microprocessor may also store at least one program (e.g., a program relating to manipulation of the variable). In some cases, the microprocessor may accept digital data (e.g., data from the digital input sensing device) as input, perform one or more processes manipulating the at least one variable, and provide digital data as output.

FIG. 2 illustrates a schematic representation of a touch-sensitive switch, according to some embodiments. In FIG. 2, a touch-sensitive switch comprises a first touch-sensitive conductive element 6 and a second touch-sensitive conductive element 5. First conductive element 6 and second conductive element 5 are separated by an insulating space 3 and therefore are not in electrical contact. However, first conductive element 6 and second conductive element 5 are in close proximity to each other, such that a human finger can simultaneously touch both conductive elements.

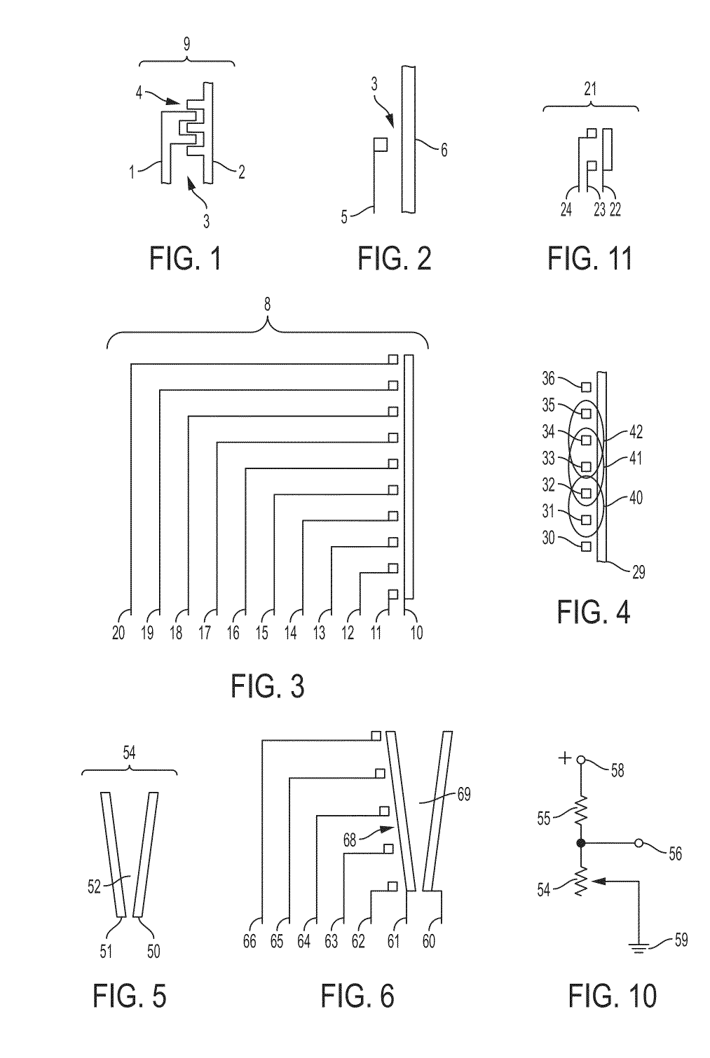

FIG. 1 shows a detailed illustration of an exemplary embodiment of a touch-sensitive switch. In FIG. 1, touch-sensitive switch 9 comprises first touch-sensitive conductive element 2 and second touch-sensitive conductive element 1. First conductive element 2 and second conductive element 1 each comprise a plurality of elements (e.g., prongs) that comprise interleaving conductive elements 4. Interleaving conductive elements 4 are configured such that the elements of first conductive element 2 are positioned between the elements of second conductive element 1 (e.g., prongs from first conductive element 2 alternate with prongs from second conductive element 1). Interleaving conductive elements 4 may increase the potential for a finger to form a conductive bridge between first conductive element 2 and second conductive element 1, such that touch-sensitive switch 9 is closed (e.g., such that electrical closure of touch-sensitive switch 9 can be detected by a digital input sensing device).

Some aspects are directed to an array of touch-sensitive switches formed from a plurality of touch-sensitive conductive elements. In some embodiments, the array is a linear array of touch-sensitive switches. In certain cases, the array of touch-sensitive switches comprises a first touch-sensitive conductive element that forms a common conductive element for a plurality of touch-sensitive switches. For example, the first touch-sensitive conductive element may be a long conductive element. In some cases, the first touch-sensitive conductive element has a first conductive area that is relatively large. In some embodiments, the array further comprises at least one second touch-sensitive conductive element that is not in contact with the first touch-sensitive conductive element. The at least one second touch-sensitive conductive element may be positioned in close proximity to the first touch-sensitive conductive element, such that the first and second conductive elements form a touch-sensitive switch that can be closed by a finger. The second touch-sensitive conductive element may have a second conductive area that is smaller than the first conductive area of the first touch-sensitive conductive element. In some embodiments, the array comprises a plurality of second touch-sensitive conductive elements, each positioned in close proximity to the first touch-sensitive conductive element, such that the first and second conductive elements form a plurality of touch-sensitive switches that can each be closed by a finger. In some embodiments, the array comprises at least 2 touch-sensitive conductive switches, at least 5 touch-sensitive conductive switches, at least 10 touch-sensitive conductive switches, at least 20 touch-sensitive conductive switches, at least 50 touch-sensitive conductive switches, or more. In some embodiments, a plurality of touch-sensitive switches can be closed simultaneously. For example, the first conductive element and plurality of second conductive elements may be positioned such that a finger can simultaneously touch at least a portion of the first conductive element and at least a portion of two or more second conductive elements.

FIG. 11 illustrates an exemplary embodiment of a linear array 21 comprising two touch-sensitive switches. The array comprises a first touch-sensitive conductive element 22, a second touch-sensitive conductive element 23, and another second touch-sensitive element 24. First conductive element 22 and second conductive element 23 form a first touch-sensitive switch. First conductive element 22 and second conductive element 24 form a second touch-sensitive switch. The linear array of two touch-sensitive switches can form an up-down controller (e.g, a two-element linear controller). For example, conductive element 23 may be a down direction element. When first touch-sensitive switch comprising first conductive element 22 and second conductive element 23 is closed, a variable of interest may be decremented. In contrast, conductive element 24 may be an up direction element. When second touch-sensitive switch comprising first conductive element 22 and second conductive element 24 is closed, a variable of interest may be incremented. In some embodiments, the amount that the variable is incremented and/or decremented may be a function of the amount of time the first and/or second touch-sensitive switches are closed. In certain cases, briefly tapping the first and/or second touch-sensitive switches can result in fine tuning the value of the variable.

In some embodiments, the array comprises more than two touch-sensitive switches. FIG. 3 illustrates an exemplary embodiment of a linear array comprising ten touch-sensitive switches. In FIG. 3, linear array 8 comprises a first touch-sensitive conductive element 10 and ten second touch-sensitive conductive elements 11, 12, 13, 14, 15, 16, 17, 18, 19, and 20. First conductive element 10 is not in electrical contact with any of the second conductive elements. Each of the second conductive elements is positioned in close proximity to first conductive element 10, such that ten touch-sensitive switches are formed. In operation, a finger may slide along at least a portion of first conductive element 10, such that at least two touch-sensitive switches are successively opened (e.g., deactivated) and closed (e.g., activated). In some embodiments, linear array 8 is a linear slide potentiometer.

In certain cases, a plurality of adjacent touch-sensitive switches of an array form a cluster of touch-sensitive switches. A cluster may comprise 2 touch-sensitive switches, 3 touch-sensitive switches, 4 touch-sensitive switches, 5 touch-sensitive switches, or more. In some embodiments, a first cluster of touch-sensitive switches may be closed by a finger at an initial time. As the finger slides along the array of touch-sensitive switches, the finger may lose contact with at least one of the switches in the first cluster of touch-sensitive switches. The finger may subsequently gain contact with a second cluster of touch-sensitive switches, such that the second cluster of touch-sensitive switches is closed. The transition from closure of the first cluster of touch-sensitive switches to closure of the second cluster of touch-sensitive switches may provide rate information. Such information may, for example, provide greater resolution than the total number of touch-sensitive switches forming the array.

FIG. 4 illustrates an exemplary embodiment of clusters of touch-sensitive switches (e.g., touch points) that may be closed (e.g., depressed) by a finger. FIG. 4 shows a first touch-sensitive conductive element 29, which corresponds to first conductive element 10 in FIG. 3. FIG. 4 also shows seven second touch-sensitive conductive elements 30, 31, 32, 33, 34, 35, and 36. These second touch-sensitive conductive elements may correspond to any seven adjacent second touch-sensitive conductive elements illustrated in FIG. 3. The seven second touch-sensitive conductive elements form seven touch-sensitive switches with first touch-sensitive conductive element 29. Three clusters of touch-sensitive switches are shown in FIG. 4. First cluster 40 comprises conductive elements 29, 31, and 32. Second cluster 41 comprises conductive elements 29, 32, 33, and 34. Third cluster 42 comprises conductive elements 29, 33, 34, and 35.

In operation, a finger may contact first cluster 40 (e.g., simultaneously contact at least a portion of conductive elements 29, 31, and 32). The finger may then slide upward along conductive element 29. As the finger ascends, it may lose contact with at least a portion of first cluster 40 and may contact second cluster 41 (e.g., simultaneously contact at least a portion of conductive elements 29, 32, 33, and 34). As the finger further ascends, it may lose contact with at least a portion of second cluster 41 and may contact third cluster 42 (e.g., simultaneously contact at least a portion of conductive elements 29, 33, 34, and 35). As the finger moves up and down the array of touch-sensitive switches, different clusters may be contacted. In addition to position information, information relating to the amount of pressure applied by the finger and the rate of movement of the finger may be provided. Such information may provide greater resolution than could be obtained from position information alone.

In a particular, non-limiting example, the ten touch points of FIG. 3 may represent numerical control levels between 0 and 99, with ten selected values as follows:
first conductive element 11=0
second conductive element 12=10
third conductive element 13=20
fourth conductive element 14=30
fifth conductive element 15=40
sixth conductive element 16=50
seventh conductive element 17=60
eighth conductive element 18=70
ninth conductive element 19=80
tenth conductive element 20=90

A first cluster (e.g., a first touch zone cluster) may comprise sixth conductive element 16 with an equivalent absolute numerical value of 50, seventh conductive element 17 with an equivalent absolute numerical value of 60, and eighth conductive element 18 with an absolute numerical value of 70. The middle conductive element of the cluster, seventh conductive element 17 with an equivalent absolute numerical value of 60, may be considered the desired level. If, while contacting the first touch zone cluster, momentary contact is made with ninth conductive element 19, which has an equivalent absolute numerical value of 80, the absolute numerical value of 60 may increment to absolute numerical value 61, then 62, then 63, etc. In such a manner, greater resolution can be derived by varying the momentary contact time and making repeated contacts with adjacent higher or lower touch points, than could be obtained by simply closing one of the touch-sensitive switches or a cluster of touch-sensitive switches. If the finger lost contact with sixth conductive element 16, which has an equivalent absolute numerical value of 50, and made longer contact with ninth conductive element 19, which has an equivalent absolute numerical value of 80, the absolute numerical value would advance to absolute numerical value 70, which would then be the center value (e.g., of eighth conductive element 18).

Some embodiments are related to methods associated with the input devices described herein. In some embodiments, a method may comprise providing a device comprising a non-conductive substrate, at least one touch-sensitive switch comprising first touch-sensitive conductive element and a second touch-sensitive conductive element, where the second touch-sensitive conductive element is not in electrical contact with the first touch-sensitive conductive element. In some embodiments, the at least one touch-sensitive switch is printed on the non-conductive substrate. In certain cases, the first touch-sensitive conductive element and/or second touch-sensitive conductive element comprise a conductive ink. In some embodiments, the method may further comprise the step of positioning a human finger such that a conductive bridge is formed between the first touch-sensitive conductive element and the second touch-sensitive conductive element. The method may also comprise the step of moving the finger from a first position to a second position.

Some aspects are directed to an input device comprising a first touch-sensitive conductive element comprising a conductive rail and a second touch-sensitive conductive element comprising a conductive rail, where the second conductive rail is not in electrical contact with the first conductive rail. In some cases, the second conductive rail may be positioned in close proximity to the first conductive rail, such that a finger can simultaneously touch at least a portion of each of the first and second conductive rails. The finger may provide a conductive and corresponding electrically resistive path between the non-contacting conductive rails. Each conductive rail may be long enough such that the tip of a finger may slide along at least a portion of each conductive rail. In some embodiments, the first touch-sensitive conductive element and/or the second touch-sensitive conductive element comprises a conductive ink. In some embodiments, the first touch-sensitive conductive element and/or the second touch-sensitive conductive element is printed on a substrate (e.g., a flat, non-conductive substrate). In some embodiments, the input device comprises a z-axis deposition of ink that can serve as a protective coating.

In some embodiments, the first and second conductive rails have inner edges that are not parallel over at least a portion of their length. In devices comprising non-parallel conductive rails, the electrical resistance between the first conductive rail and the second conductive rail may vary as a function of position of a finger providing a conductive bridge between the first and second conductive rails. In some embodiments, the non-contacting, non-parallel conductive rails form a variable resistance input device (e.g., a variable resistance slide potentiometer).

In some embodiments, the variable resistance input device is part of a system comprising a power source, a microprocessor, and electronics (e.g., a digital input sensing device). The microprocessor may store at least one variable v, which may be altered based on input from the variable resistance input device and the digital input sensing device. In some embodiments, the variable may be a mathematical variable having a value that is real, imaginary, or complex. The microprocessor may also store at least one program (e.g., a program relating to manipulation of variable v).

In operation, a finger may simultaneously contact the first conductive rail and second conductive rail at a position y, resulting in a particular resistance. The resistance may be measured by the digital input sensing device and transmitted to the microprocessor. Since resistance is a function of finger position, the microprocessor may be able to calculate the finger position y based on the measured resistance. In certain cases, the microprocessor may alter (e.g., increment or decrement) the value of variable v based on finger position y. For example, a position y higher than a certain programmed value may result in the variable being incremented, while a position y lower than a certain programmed value may result in the variable being decremented.

An exemplary embodiment of a variable resistance input device comprising two conductive rails is shown in FIG. 5. In FIG. 5, a variable resistance input device 54 is formed by a first conductive rail 50 and a second conductive rail 51, where first conductive rail 50 and second conductive rail 51 are separated by insulating space 52. As shown in FIG. 5, second conductive rail 51 is not parallel to first conductive rail 50.

In operation, a finger may simultaneously contact at least a portion of first conductive rail 50 and at least a portion of second conductive rail 51. In a particular example, the finger may initially be positioned at the bottom of variable resistance input device 54. Because first conductive rail 50 and second conductive rail 51 are closest together at the bottom of variable resistance input device 54, resistance at that location would be the lowest. The finger may subsequently slide upwards along the conductive rails. As the finger ascends and contacts the conductive rails at locations with greater distance between the conductive rails, the resistance between first conductive rail 50 and second conductive rail 51 may increase. In some cases, the finger may slide downwards along the conductive rails. As the finger descends, the resistance between first conductive rail 50 and second conductive rail 51 may decrease.

FIG. 10 shows a schematic circuit diagram showing an exemplary system incorporating variable resistance device 54. In FIG. 10, a system comprises variable resistance input device 54 in series with a fixed resistor 55. Both variable resistance input device 54 and fixed resistor 55 are connected between positive voltage source 58 and ground 59. A center tap (e.g., an electrical contact) 56 is located between fixed resistor 55 and variable resistance input device 54. The center tap may, for example, be electrically connected to a digital input sensing device, a voltmeter, or another electrical element. In operation, as a finger slides up and down variable resistance input device 54, the voltage at center tap 56 may increase or decrease (e.g., the voltage may decrease as resistance increases, and the voltage may increase as resistance decreases).

Some aspects are directed to an input device comprising a first conductive rail, a second conductive rail, and one or more third touch-sensitive conductive elements. The one or more third touch-sensitive conductive elements may not be in electrical contact with the first or second conductive rails. In some embodiments, the first and second conductive rails have inner edges that are not parallel over at least a portion of their length. In some cases, the one or more third touch-sensitive conductive elements may be positioned in close proximity to at least one of the conductive rails, such that each third touch-sensitive conductive element forms a touch-sensitive switch (e.g., touch point) with at least one of the conductive rails, where each touch-sensitive switch can be closed by a finger. In some cases, the input device is configured such that a finger can make electrical contact with at least a portion of the first conductive rail, at least a portion of the second conductive rail, and at least one third touch-sensitive conductive element. The at least one third touch-sensitive conductive element contacted by the finger may provide additional position information about the finger. In some embodiments, the at least one third touch-sensitive conductive element comprises a conductive element. In certain embodiments, the at least one third touch-sensitive conductive element is printed on a substrate (e.g., a flat, non-conductive substrate). In some embodiments, the input device further comprises a z-axis non-isotropic deposition of ink. The input device may also comprise at least one layer of non-conductive ink.

In some embodiments, the first and second conductive rails are sufficiently long that the finger contacts only a portion of the total length of the conductive rails at any given time, and the finger can slide from one region to another region as if sliding a fader rheostat. In operation, the finger may come into contact with different touch points as it slides up and down the first and second conductive rails. The touch points may provide position information, which may be used for calibration and addition of correction factors to enhance the accuracy of the position information obtained, for example, from resistance measurements. This additional position information may be particularly important for touch-sensitive input devices because the resistance of a human finger can vary with dryness, moisture, and/or intrinsic skin resistance.

In some embodiments, the position information can be used for interpolation of resistance measurements across the first and second conductive rails. For example, linear interpolation can be used to provide position information between adjacent touch points. If a first resistance is measured at the first touch point and a second resistance is measured at the second touch point, and a third resistance with a value between the first and second resistance values is known, interpolation can be used to obtain the position corresponding to the third resistance. The calibration (e.g., interpolation) between the first and second touch points may be different from the calibration between the second and third touch points or the third and fourth touch points. Each region between two adjacent touch points may have a different calibration regime than any region between two other adjacent touch points. A more accurate model of the variable resistance input device may thus be obtained by associating a resistance with each additional touch point. Due to resistance changes due to moisture, temperature, intrinsic drift, and/or changing skin resistance, calibration may involve a dynamic adjustment over time.

In some embodiments, the variable resistance input device is part of a system comprising a power source, a microprocessor, and electronics (e.g., a digital input sensing device). The microprocessor may store at least one variable v, which may be altered based on input from the variable resistance input device and the digital input sensing device. In some embodiments, the variable may be a mathematical value having a value that is real, imaginary, or complex.

FIG. 6 shows an illustration of an exemplary embodiment of a variable resistance input device comprising a plurality of touch points. The variable input device of FIG. 6 may, for example, provide more calibrated position information than the variable input device of FIG. 5. As shown in the FIG. 6, the variable resistance input device comprises a first conductive rail 61 and a second conductive rail 60, where first conductive rail 61 and second conductive rail 60 are separated by insulating space 69 such that the two conductive rails are not in electrical contact. In FIG. 6, third conductive elements 62, 63, 64, 65, and 66 are positioned adjacent first conductive rail 61. The third conductive elements are separated from first conductive rail 61 by insulating space 68, such that the third conductive elements are not in electrical contact with first conductive rail 61. The third conductive elements may provide position information. For example, conductive element 62 may be a zero scale calibration touch point, conductive element 63 may be a quarter scale calibration touch point, conductive element 64 may be a half scale calibration touch point, conductive element 65 may be a three quarter scale calibration touch point, and conductive element 66 may be a full scale calibration touch point.

In operation, a finger may be positioned at the bottom of the device, where resistance is lowest (e.g., because first conductive rail 61 and second conductive rail 60 are closest together at the bottom of the device). The finger positioned at the bottom of the device may simultaneously contact at least a portion of first conductive rail 61, at least a portion of second conductive rail 60, and at least a portion of zero scale calibration touch point 62. Zero scale calibration touch point 62 may provide information about the position of the finger (e.g., to a digital input sensing device and/or a microprocessor), and the resistance measured when the finger was at the known location may be stored. The finger may move upwards to quarter scale calibration touch point 63. The resistance at quarter scale calibration touch point 63 may be greater than the resistance at zero scale calibration touch point 62 due to the greater distance between the first and second conductive rails. Given the resistance value at zero scale calibration touch point 62 and the resistance value at quarter scale calibration touch point 63, interpolation can occur. Thus, given a resistance measurement having a value between the resistance values at the zero scale and quarter scale calibration touch points, the position of the finger between zero scale and quarter scale can be determined. Similarly, the finger may further ascend and come into contact with half scale calibration touch point 64. The resistance at half scale calibration touch point 64 may be greater than the resistance at quarter scale calibration touch point 63. Given the resistance values at quarter scale calibration touch point 63 and half scale calibration touch point 64, interpolation can occur. Based on a resistance measurement having a value between the resistance values at quarter scale 63 and half scale 64, the position of the finger between quarter scale 63 and half scale 64 can be determined. Similar interpolations can be made as the finger further ascends and comes into contact with three quarter scale calibration touch point 64 and full scale calibration touch point 66. In the particular device shown in FIG. 6, there are four interpolation regions between adjacent touch points. However, an input device may have any number of interpolation regions (e.g., one, two, three, four, five, or more).

Some aspects are directed to an area matrix comprising three or more touch-sensitive switches (e.g., touch points). An input device comprising an area matrix may be a two-dimensional input device, according to some embodiments. In some embodiments, a finger may move within the area of an area matrix, and position may be sensed within the matrix due to the opening and closing of touch-sensitive switches.

In some embodiments, a two-dimensional input device comprises a non-conductive substrate, a matrix of touch-sensitive switches, a power source, a microprocessor, and electronics (e.g., a digital input sensing device). Each touch-sensitive switch may comprise a first touch-sensitive conductive element and a second touch-sensitive conductive element that is not in electrical contact with the first touch-sensitive conductive element. In some embodiments, the first touch-sensitive conductive element and/or the second touch-sensitive conductive element comprise a conductive ink. The first touch-sensitive conductive element and/or the second touch-sensitive conductive element may be printed on a substrate (e.g., a flat substrate), according to some embodiments. The matrix of touch-sensitive switches may be square, rectangular, irregular in bounding perimeter, not composed of linear rows and/or linear columns, and/or formed in a topological configuration so as to fill and/or cover an area bounded by a perimeter.

In an exemplary embodiment, a two-dimensional input device may comprise H number of electrically conductive horizontal lines (e.g., bus lines) and V number of electrically conductive vertical lines (e.g., bus lines), where H and V are whole numbers. At least one touch-sensitive switch can be formed at each intersection of the H number of horizontal lines and the V number of vertical lines, such that an area matrix comprising at least H×V touch-sensitive switches can be formed. In some embodiments, each touch-sensitive switch comprises a first touch-sensitive conductive element and a second touch-sensitive conductive that are configured such that a finger can form a conductive bridge between the two conductive elements and thereby close the switch.

In some embodiments, two or more adjacent touch-sensitive switches can form a cluster. A finger may result in a cluster of closures (e.g., all the switches in the cluster are simultaneously closed by the finger). In operation, a finger may move across the area matrix. For example, the finger may move from a first cluster to a second cluster. The transition from one cluster to another may provide rate information, which may allow greater resolution than the total number of touch-sensitive switches forming the area matrix.

In some embodiments, the area matrix further comprises at least one supplemental source of position information. For example, the supplemental source may include a touch-sensitive switch, an array comprising at least one touch-sensitive switch, and any other source of additional position information. Information from the supplemental source may provide additional information to modify the information derived from the area matrix. In some embodiments, the additional information can result in fine control that can supplement coarse control derived from the area matrix (e.g., the resolution may be greater than the H×V total number of touch-sensitive switches within the area matrix).

In some embodiments, the matrix of touch-sensitive switches is a matrix of matrices comprising touch-sensitive switches. The matrix of matrices can comprise the same number of H electrically conductive horizontal lines and V electrically conductive vertical lines. The redundant conductive horizontal lines and redundant conductive vertical lines may be configured such that the path of a finger across the area of the matrix of matrixes defines a unique position.

In some embodiments, the two-dimensional input device further comprises an insulation layer. In some cases, the insulation layer may advantageously prevent a short circuit. For example, the insulation layer may prevent a first electrically conductive line from coming into contact with a second electrically conductive line. The insulation layer may prevent a first electrically conductive horizontal line from coming into electrical contact with a second electrically conductive horizontal line, an electrically conductive horizontal line from coming into electrical contact with an electrically conductive vertical line, or a first electrically conductive vertical line from coming into contact with a second electrically conductive vertical line.

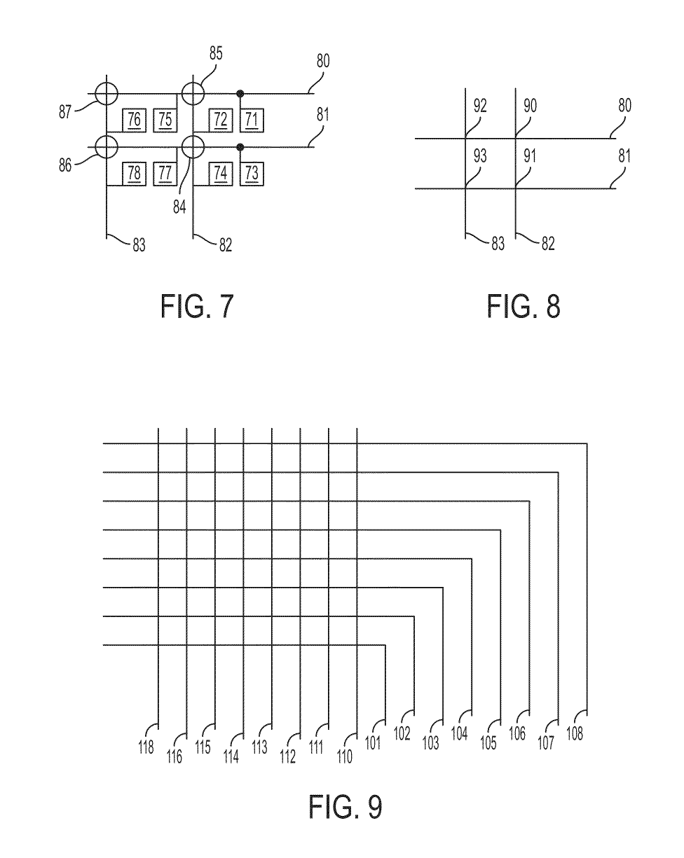

FIG. 7 illustrates an exemplary embodiment of an input device comprising a conductive area matrix. In FIG. 7, an input device comprises an upper electrically conductive horizontal line 80, a lower electrically conductive horizontal line 81, a right electrically conductive vertical line 82, and a left electrically conductive vertical line 83. As shown in FIG. 7, the input device comprises four touch-sensitive switches: a first touch-sensitive switch comprising conductive elements 71 and 72, a second touch-sensitive switch comprising conductive elements 73 and 74, a third touch-sensitive switch comprising conductive elements 75 and 76, and a fourth touch-sensitive switch comprising elements 77 and 78. Each touch-sensitive switch comprises a conductive element connected to an electrically conductive horizontal line and a conductive element connected to an electrically conductive vertical line. Conductive elements 71 and 75 are connected to upper electrically conductive horizontal line 80. Conductive elements 73 and 77 are connected to lower electrically conductive horizontal line 81. Conductive elements 72 and 74 are connected to right electrically conductive vertical line 82. Conductive elements 76 and 78 are connected to left electrically conductive vertical line 83. To avoid shorting between the electrically conductive vertical and horizontal lines, the input device may further comprise one or more insulation layers (e.g., patches) to insulate the electrically conductive lines from each other. The insulation layers may be printed or applied. In some embodiments, the insulation layers may comprise a non-conductive ink or any other non-conductive material. In FIG. 7, the input device comprises upper right insulation patch 85 to prevent shorting between upper electrically conductive horizontal line 80 and right electrically conductive vertical line 82, upper left insulation patch 87 to prevent shorting between upper electrically conductive horizontal line 80 and left electrically conductive vertical line 83, lower right insulation patch 84 to prevent shorting between lower electrically conductive horizontal line 81 and right electrically conductive vertical line 82, and lower left insulation patch 86 to prevent shorting between lower electrically conductive horizontal line 81 and left electrically conductive vertical line 83.

The area matrix of FIG. 7 is schematically shown in FIG. 8. In FIG. 8, upper right cross point 90 represents the first touch-sensitive switch comprising conductive elements 71 and 72, lower right cross point 91 represents the second touch-sensitive switch comprising conductive elements 73 and 74, upper left cross point 92 represents the third touch-sensitive switch comprising conductive elements 75 and 76, and lower left cross point 93 represents the fourth touch-sensitive switch comprising elements 77 and 78.

In some embodiments, the area matrix comprises more than four touch-sensitive switches. Using the schematic representation of FIG. 8, an 8-by-8 area matrix comprising 64 touch-sensitive switches is shown in FIG. 9. The device comprises 8 electrically conductive horizontal lines (first horizontal line 101, second horizontal line 102, third horizontal line 103, fourth horizontal line 104, fifth horizontal line 105, sixth horizontal line 106, seventh horizontal line 107, and eighth horizontal line 108). The device also comprises 8 electrically conductive vertical lines (first vertical line 110, second vertical line 111, third vertical line 112, fourth vertical line 113, fifth vertical line 114, sixth vertical line 115, seventh vertical line 116, and eighth vertical line 118). The matrix therefore has a total of 16 lines and 64 cross points. FIG. 9, which is a schematic representation, does not show the insulation patches that could prevent shorting at each cross point.

Some aspects are directed to an input device comprising at least two switches located within an area, at least one memory storage register for storage of at least one variable, and a microprocessor (e.g., a device having the processing ability to increment and/or decrement at least one variable). In some embodiments, the input device comprises at least four switches, at least six switches, at least eight switches, or more. In some embodiments, the switches are touch-sensitive switches.

In some embodiments, the variable being altered may be real, imaginary, or complex. In some cases, the variable v has a first component v₁ and a second component v₂. In some embodiments, each switch i of the input device is positionally defined by X and Y coordinates Xᵢ and Yᵢ, where i is a whole number between 1 and N total number of switches. In certain cases, the variable v can be represented as a point positionally defined by X and Y coordinates Xᵥ and Yᵥ. In some embodiments, Xᵥ is the first component of variable v, and Yᵥ is the second component of variable v.

In operation, closing a switch having the X and Y coordinates Xᵢ, Yᵢ may cause the first component v₁ of variable v to increment if Xᵢ is less than Xᵥ or to decrement if Xᵢ is less than Xᵥ. In some embodiments, the Xᵥ component will increment toward Xᵢ if Xᵢ is greater than Xᵥ or decrement toward Xᵢ if Xᵢ is less than Xᵥ. In some cases, closing the switch may cause the second component v₂ of variable v to increment if Yᵢ is greater than Yᵥ or to decrement if Yᵢ is less than Yᵥ. In some embodiments, the Yᵥ component will increment toward Yᵢ if Yᵢ is greater than Yᵥ or decrement toward Yᵢ if Yᵢ is less than Yᵥ. The rate of incrementing and/or decrementing may be independently determined. Xᵥ, Yᵥ can thus slowly or quickly move in the direction of Xᵢ, Yᵢ. In some cases, closing any two adjacent switches can create the position of a virtual switch located halfway between the two adjacent switches defined as follows:

first switch A has coordinates Xₐ, Yₐ;

second adjacent switch B has coordinates X_{b}, Y_{b};

the mathematically virtual switch AB has an X_{ab} coordinate defined by ((Xₐ−X_{b})/2+X_{b}) and a Y_{ab} coordinate defined by ((Yₐ−Y_{b})/2+Y_{b}), thus creating the mathematically virtual switch defined by coordinates X_{ab}, Y_{ab}.

In some cases, a virtual switch may advantageously provide additional directional resolution. The virtual switch may be particularly advantageous in cases where it is desired to alter the variable in a direction halfway between two adjacent switches.

In some embodiments, thus, the components v₁ and v₂ of a variable may be changed in any number of ways by closing one or more switches in an area matrix. In some cases, the Xᵥ, Yᵥ coordinates representing the variable may cause the value of the components of the variable to change in accordance with and in the direction of a closed switch and/or a virtual switch. Therefore, in some cases, it may be possible to steer a variable represented by a point located within an area in the direction of any switch. By pressing a different switch, the point may continue from its last location and move in the direction of the new switch and/or virtual switch being depressed.

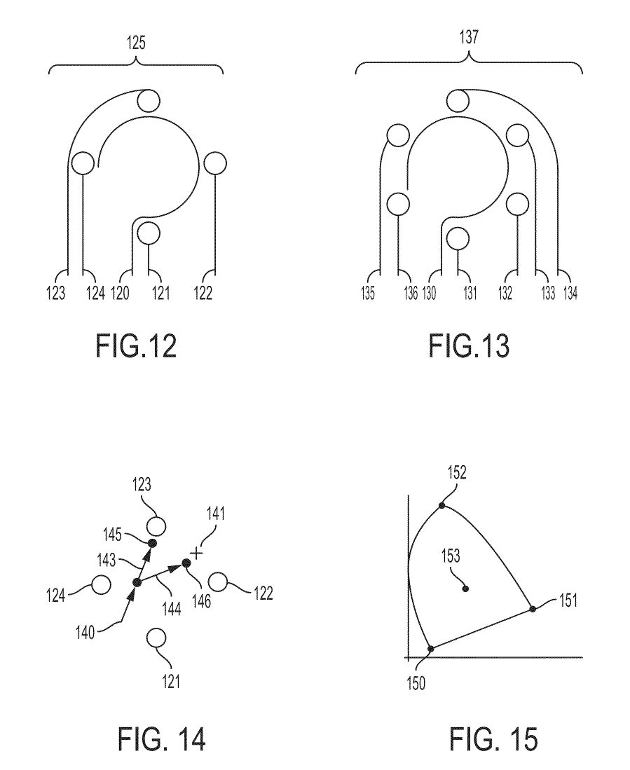

FIG. 12 illustrates an exemplary embodiment of a four point area controller 125 comprising a south conductive element 121, an east conductive element 122, a north conductive element 123, and a west conductive element 124. Each of the four conductive elements forms a switch with four point common 120. In operation, the four point area controller may be used to alter the value of a two-dimensional variable comprising two independent values.

FIG. 14 shows the four point area controller 125 of FIG. 12. In FIG. 14, a two-dimensional variable is represented by a point having (X, Y) starting coordinates 140. If north conductive element 123 is pressed (e.g., closing the north touch-sensitive switch), (X, Y) starting location 140 changes along trajectory path 143, from (X, Y) location 140 to (Xₙ, Yₙ) location 145. If, instead of only north conductive element 123 being pressed, both north conductive element 123 and east conductive element 122 are simultaneously pressed, (X, Y) starting location 140 changes along trajectory path 144, from (X, Y) location 140 to (Xₙₑ, Yₙₑ) location 146. Trajectory path 144 is in virtual direction 141, which is a north-east direction. These non-limiting examples demonstrate how the (X, Y) coordinates can be changed according to which switches or combinations of switches are closed.

FIG. 13 illustrates an exemplary embodiment of a six point area controller. In FIG. 13, six point area controller 137 comprises 0 degree conductive element 134, 60 degree conductive element 133, 120 degree conductive element 132, 180 degree conductive element 131, 240 degree conductive element 136, 300 degree conductive element 135. Each conductive element forms a switch with six point common 130. Six point area controller 137 is similar to the four point area controller of FIG. 12, although the six point area controller may provide additional angular steering resolution.

FIG. 15 shows a CIE (International Commission on Illumination) chromaticity diagram as a non-limiting example of an area representation that could be superimposed on FIG. 12, FIG. 13, or any other area map. In FIG. 15, the locations of blue 150, red 151, green 152, and white 153 are shown. The colors of the chromaticity diagram may be generated by any color-reproducing source that is color calibrated. In some embodiments, a color-reproducing element could produce a certain color in response to a given set of X, Y coordinates. The X, Y coordinates may be changed using the area controllers described herein, thereby changing the color that is produced.

Although preferred embodiments of the present invention have been described, it will be understood by those skilled in the art that the present invention should not be limited to the described preferred embodiments. Rather, various changes and modifications can be made within the spirit and scope of the present invention.

1. A printed substrate for a flat computation, communication, and I/O system comprising of:
a non-conductive substrate;
at least one first touch sensitive conductive element; and
at least one second touch sensitive conductive element not in electrical contact with said at least one first touch sensitive conductive element.

2. The printed substrate for a flat computation, communication, and I/O system of claim 1, wherein said at least one first touch sensitive conductive element and at least one second touch sensitive conductive element not in electrical contact with said at least one first touch sensitive conductive element form at least one touch sensitive switch.

3. The printed substrate for a flat computation, communication, and I/O system of claim 2, wherein said at least one touch sensitive switch is a linear array of touch sensitive switches.

4. The input array of claim 3, wherein said linear array of touch sensitive switches is configured such that a finger and/or skin is capable if being placed and/or slid in a manner enabling the conductive bridging between said at least one first touch sensitive conductive element and said at least one second touch sensitive conductive element.

5. The printed substrate for a flat computation, communication, and I/O system of claim 1, wherein said at least one first touch sensitive element is a long conductive element.

6. The printed substrate for a flat computation, communication, and I/O system of claim 5, wherein said at least one second conductive element is at least one small conductive area located in close proximity to said at least one long conductive element.

7. The printed substrate for a flat computation, communication, and I/O system of claim 6, wherein said long conductive element forms the said first touch sensitive conductive element for more than one said second touch sensitive conductive element.

8. The printed substrate for a flat computation, communication, and I/O system of claim 6, wherein the tip of a human finger and/or skin can be placed upon and conductively bridge between at least a portion of the length of said at least one first touch sensitive element and at least a portion said at least one second conductive element.

9. The printed substrate for a flat computation, communication, and I/O system of claim 3, wherein the tip of a human finger and/or skin is be placed across and/or slid along at least a portion of said array of touch sensitive switches such that said at least one touch sensitive conductive switch is activated and/or closed and/or deactivated and/or opened followed by another adjacent said at least one touch sensitive conductive switch being activated and/or closed and/or deactivated and/or opened.

10. The printed substrate for a flat computation, communication, and I/O system of claim 9, wherein one or more adjacent touch sensitive conductive switches is a cluster of touch sensitive switch closures.

11. The printed substrate for a flat computation, communication, and I/O system of claim 10, wherein said cluster of touch sensitive switch closures becomes a different cluster of touch sensitive switch closures as said human finger and/or skin slides along said linear array of touch sensitive switches.

12. The printed substrate for a flat computation, communication, and I/O system of claim 11, wherein the transition from one said cluster of touch sensitive switch closures to an adjacent and different said cluster of touch sensitive switch closures and/or more than one said transition provides rate information for deriving greater resolution than the total number of touch sensitive switches forming said printed substrate for a flat computation, communication, and I/O system.

13. The printed substrate for a flat computation, communication, and I/O system of claim 1, further comprising of a Z axis non-isotropic deposition of ink.

14. The printed substrate for a flat computation, communication, and I/O system of claim 1, wherein said non-conductive substrate is at least one layer of non-conductive ink.

15. A device comprising:
a non-conductive substrate; and
at least one touch-sensitive switch comprising:
a first touch-sensitive conductive element;
a second touch-sensitive conductive element, wherein the second touch-sensitive conductive element is not in electrical contact with the first touch-sensitive conductive element;
wherein the at least one touch-sensitive switch is printed on the non-conductive substrate.

16. The device of claim 15, wherein the first touch-sensitive conductive element and/or the second touch-sensitive conductive element comprise a conductive ink.

17. The device of claim 15, wherein the at least one touch-sensitive switch is configured such that a human finger can form a conductive bridge between at least a portion of the first touch-sensitive conductive element and at least a portion of the second touch-sensitive conductive element.

18. The device of claim 15, wherein the at least one touch-sensitive switch is a linear array of touch-sensitive switches.

19. The device of claim 15, wherein the first touch-sensitive element is a long conductive element.

20-28. (canceled)

29. A method, comprising:
providing a device comprising:
a non-conductive substrate; and
at least one touch-sensitive switch comprising:
a first touch-sensitive conductive element comprising a conductive ink; and
a second touch-sensitive conductive element comprising a conductive ink, wherein the second touch-sensitive conductive element is not in electrical contact with the first touch-sensitive conductive element,
wherein the at least one touch-sensitive switch is printed on the non-conductive substrate; and
positioning a human finger such that a conductive bridge is formed between the first touch-sensitive conductive element and the second touch-sensitive conductive element.

30-127. (canceled)
